(19) United States
(12) Patent Application Publication
(10) Pub. No.: US 2020/0183164 A1
(43) Pub. Date: Jun. 11, 2020

(54) DRIVE DEVICE AND HEAD-UP DISPLAY DEVICE

(71) Applicant: NIDEC SANKYO CORPORATION, NAGANO (JP)

(72) Inventors: Takafumi KASUGA, NAGANO (JP); Hiroyuki HATASAKO, NAGANO (JP); Takahisa UEKI, NAGANO (JP)

(73) Assignee: NIDEC SANKYO CORPORATION, NAGANO (JP)

(21) Appl. No.: 16/702,552

(22) Filed: Dec. 4, 2019

(30) Foreign Application Priority Data
Dec. 5, 2018 (JP) 2018-228208

(51) Int. Cl. G02B 27/01; B60K 35/00; G02B 7/182

(52) U.S. Cl. CPC G02B 27/0149; B60K 35/00; B60K 2370/1529; G02B 2027/0169; G02B 7/1821

(57) ABSTRACT

A drive device includes a drive part and a movable member structured to be moved by the drive part. The movable member includes a main body part and a support part which supports a supported member. The support part includes an elastic support part which urges the supported member and a fixed support part which is provided so as to face the elastic support part in a moving direction of the movable member and supports the supported member urged by the elastic support part. The elastic support part includes an elastic support part side protruded part which is a convex curved face protruded to a side to be abutted with the supported member, and the fixed support part includes a fixed support part side protruded part which is a convex curved face protruded to a side to be abutted with the supported member.

### CROSS REFERENCE TO RELATED APPLICATION

The present invention claims priority under 35 U.S.C. § 119 to Japanese Application No. 2018-228208 filed Dec. 5, 2018, and the entire content of which is incorporated herein by reference.

### TECHNICAL FIELD

The present invention relates to a drive device and a head-up display device.

### BACKGROUND

Conventionally, a head-up display device has been known which is structured to reflect display light from a display element by a reflection member (concave mirror) to project onto a windshield of a vehicle so that a projected display image (virtual image) is visually recognized by a driver of the vehicle. In such a head-up display device, in order to adjust a reflection angle of display light by a reflection member, a drive device is commonly used which is structured to turn a mirror holder holding a concave mirror with a predetermined turning shaft as a center.

In Japanese Patent Laid-Open No. 2015-102700 (Patent Literature 1), a drive device is described in which a drive force is transmitted to a protruded piece which is partly protruded from a mirror holder toward an outer side in a radial direction of a turning shaft and thereby the mirror holder is turned. The drive device includes a stepping motor, a lead screw (feed screw) rotationally driven by the stepping motor, a guide shaft disposed in parallel to the lead screw, a frame which supports the lead screw and the guide shaft, and a slider which includes a nut threadedly engaged with the lead screw and is formed with a guide hole through which the guide shaft is penetrated. The slider reciprocates along an axial line direction of the lead screw accompanied with rotation of the lead screw, and the slider is provided with a support part which supports the protruded piece of the mirror holder which is a supported member. Therefore, when the slider which supports the protruded piece of the mirror holder reciprocates, the mirror holder is turned.

In the drive device described in Patent Literature 1, the protruded piece of the mirror holder is sandwiched and held by a pair of resin walls. However, in this structure, when a vehicle vibrates, for example, the mirror holder may move (rattle) in a moving direction of the slider and thus blur may occur in a display image by movement of the mirror holder.

### SUMMARY

In view of the problem described above, the present invention provides a drive device including a support part by which positioning accuracy of a supported member is enhanced.

To solve the above mentioned problem, the present invention provides a drive device including a drive part, and a movable member structured to be moved by a drive force of the drive part. The movable member includes a main body part and a support part supporting a supported member. The support part includes an elastic support part which urges the supported member and a fixed support part which is provided so as to face the elastic support part in a moving direction of the movable member and supports the supported member urged by the elastic support part. The elastic support part is provided with an elastic support part side protruded part which is a convex curved face protruded to a side to be abutted with the supported member, and the fixed support part is provided with a fixed support part side protruded part which is a convex curved face protruded to a side to be abutted with the supported member.

According to this embodiment, the supported member can be supported by the elastic support part side protruded part which is a convex curved face provided in the elastic support part and the fixed support part side protruded part which is a convex curved face provided in the fixed support part. In other words, the supported member can be sandwiched and supported by the protruded parts which are convex curved faces and thus, positioning accuracy of the supported member can be enhanced.

In the drive device in accordance with the present invention, it is preferable that the elastic support part includes an elastic member having the elastic support part side protruded part and an elastic member fixing part which holds the elastic member, and the elastic member fixing part is provided in the main body part. According to this structure, positioning accuracy of the supported member can be enhanced.

In the drive device in accordance with the present invention, it is preferable that the elastic member is a plate spring. According to this structure, the elastic member can be easily fixed.

In the drive device in accordance with the present invention, it is preferable that the elastic member fixing part is provided with a moving range restriction part which restricts a moving range of the elastic member. According to this structure, the elastic member is restrained from being moved excessively and from coming off from the elastic member fixing part.

In the drive device in accordance with the present invention, it is preferable that the elastic member is provided with a fixed plate part attached to the elastic member fixing part and an elastically deformable plate part which is extended from an end part of the fixed plate part and is elastically deformable, and the elastically deformable plate part is provided with a first elastic part extended from an end part of the fixed plate part and a second elastic part extended from an end part of the first elastic part. The second elastic part is provided with an abutting part structured to abut with the supported member. According to this structure, elasticity of the elastically deformable plate part can be secured.

In the drive device in accordance with the present invention, it is preferable that the first elastic part is extended on an extended line of the fixed plate part, and the second elastic part is extended at an acute angle with respect to the first elastic part. According to this structure, the elastically deformable plate part can be easily formed.

In the drive device in accordance with the present invention, it is preferable that a first supporting point part is formed between the fixed plate part and the first elastic part, the first supporting point part is defined as a boundary part between a region where the elastic member is held by the elastic member fixing part and a region where the elastic member is not held by the elastic member fixing part, and the first elastic part is elastically deformable with respect to the fixed plate part with the first supporting point part as a support point. According to this structure, elasticity of the elastically deformable plate part can be secured.

In the drive device in accordance with the present invention, it is preferable that the elastic member fixing part is provided with a protruded part which is protruded from the main body part and a restriction part provided in the protruded part, and the restriction part is formed with a gap space into which the fixed plate part is inserted between the protruded part and the restriction part to restrict a movement of the fixed plate part in a direction intersecting an inserting direction to the gap space. According to this structure, positional deviation of the elastic member can be restrained.

In the drive device in accordance with the present invention, it is preferable that the elastic member fixing part is provided with an engaging part provided in the protruded part, and the engaging part is engaged with the fixed plate part inserted into the gap space to restrict a movement of the fixed plate part to an opposite direction to the inserting direction to the gap space. According to this structure, positional deviation of the elastic member can be restrained.

In the drive device in accordance with the present invention, it is preferable that the elastic member fixing part is provided with a protruded part which is protruded from the main body part, and the protruded part is formed with a relief part which avoids an interference with the elastically deformable plate part. According to this structure, a movable range of the elastically deformable plate part can be widened.

In the drive device in accordance with the present invention, it is preferable that the relief part is a stepped part formed in the protruded part, and the stepped part is formed in a corner part of the protruded part which faces the second elastic part and has a width wider than a width of the second elastic part. According to this structure, the relief part can be easily formed and a movable range of the elastically deformable plate part can be widened.

In the drive device in accordance with the present invention, it is preferable that the fixed support part is formed of material having higher rigidity than the main body part and is partly embedded and fixed to the main body part. According to this structure, strength of the support part which supports the supported member can be increased.

In the drive device in accordance with the present invention, it is preferable that the fixed support part supports the supported member at a position facing the supported member in a moving direction of the movable member. According to this structure, positioning accuracy can be enhanced.

In the drive device in accordance with the present invention, it is preferable that at least one of the elastic support part side protruded part and the fixed support part side protruded part is provided with a convex curved face and is abutted with the supported member through the convex curved face. According to this structure, at least one of the elastic support part side protruded part and the fixed support part side protruded part can be simply formed.

In the drive device in accordance with the present invention, it is preferable that an abutting direction of the elastic support part side protruded part with the supported member deviates from a position of the fixed support part side protruded part. According to this structure, a direction to which a force is applied can be restrained from changing to an opposite side with the fixed side support part protruded part as a reference.

In the drive device in accordance with the present invention, it is preferable that the drive device further includes a lead screw which is rotationally driven by the drive part, the movable member includes a drive force transmission part structured to transmit a drive force of the drive part to the main body part and a pressurization applying part separately provided from the main body part, the drive force transmission part includes a first threaded part which is threadedly engaged with the lead screw and moves the main body part in an axial line direction of the lead screw accompanied with rotation of the lead screw, and the pressurization applying part includes a second threaded part which is threadedly engaged with the lead screw and pressurization is applied between the first threaded part and the second threaded part. According to this structure, clearances (backlash) between the lead screw and the respective threaded parts are absorbed and rattling in the moving direction of the movable member (axial line direction of the lead screw) can be suppressed.

In the drive device in accordance with the present invention, it is preferable that the drive force transmission part includes a first nut member having the first threaded part and separately provided from the main body part, the pressurization applying part includes a second nut member having the second threaded part and an urging member provided between the first nut member and the second nut member, the main body part is provided with a nut arrangement part in which the first nut member and the second nut member are disposed, and the first nut member and the second nut member are disposed in the nut arrangement part in a state that turnings of the first nut member and the second nut member with respect to the main body part are restricted. According to this structure, both of the first nut member and the second nut member can be disposed in the main body part, and a space saving of the device can be attained.

In the drive device in accordance with the present invention, it is preferable that the nut arrangement part is provided with a drive force receiving part which receives the drive force of the drive part through the first nut member, and the first nut member is applied with pressurization by the urging member through the drive force receiving part. According to this structure, the first nut member can be functioned as a drive force transmission part, and a space saving of the device can be attained.

In the drive device in accordance with the present invention, it is preferable that the urging member is a coil spring, the lead screw penetrates through an inside of the coil spring, and the urging member is disposed between the drive force receiving part and the second nut member. According to this structure, the urging member can be easily formed.

The head-up display device in accordance with the present invention includes the above-mentioned drive device and thus, a degree of freedom of a support posture of the supported member can be enhanced.

### Effects of the Invention

The drive device in accordance with the present invention is capable of enhancing positioning accuracy in a support posture of the supported member.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic structural view showing a head-up display device in accordance with an embodiment of the present invention.

FIG. 2 is a schematic cross-sectional view showing a display device of the head-up display device shown in FIG. 1.

FIG. 3 is a schematic perspective view showing a drive device in this embodiment.

FIG. 4 is a schematic side view showing a drive device in this embodiment.

FIG. 5 is a schematic enlarged perspective view showing a movable member in this embodiment.

FIG. 6 is a schematic enlarged perspective view showing the movable member in this embodiment which is viewed from a direction different from FIG. 5.

FIG. 7 is a side view showing the movable member in FIG. 5.

FIG. 8 is a plan view showing the movable member in FIG. 5.

FIG. 9 is a schematic perspective view showing an elastic member in this embodiment.

FIG. 10 is a schematic perspective view showing an elastic member fixing part in this embodiment.

FIG. 11 is a schematic perspective view showing a fixed support part in this embodiment.

FIG. 12 is a schematic side view showing the drive device in this embodiment which is viewed from an opposite side to FIG. 4.

FIG. 13 is a schematic view for explaining operation of a nut unit in this embodiment.

### DETAILED DESCRIPTION

An embodiment of the present invention will be described below with reference to the accompanying drawings.

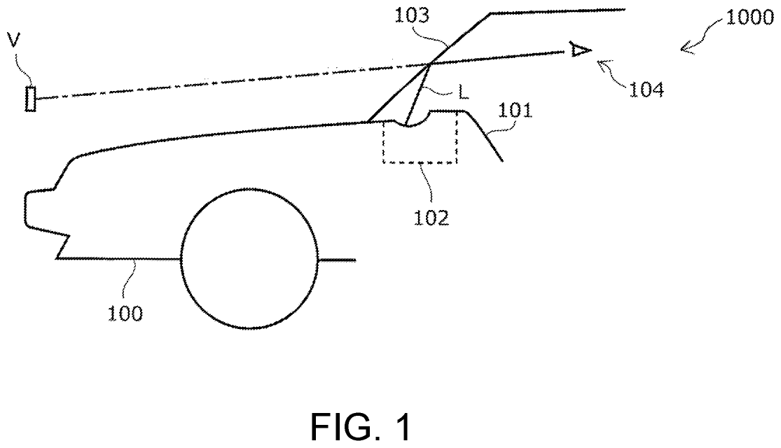

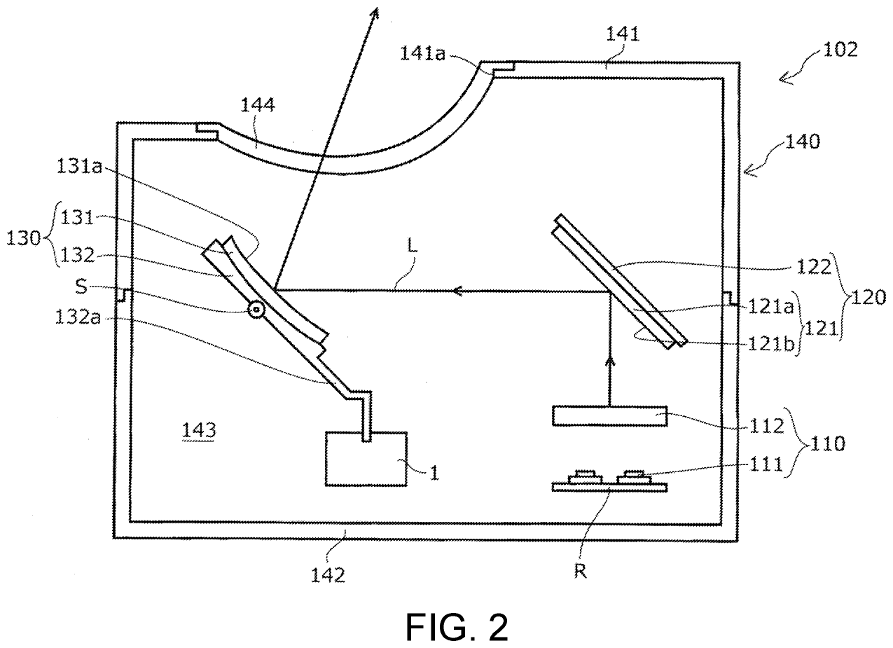

First, a head-up display device 1000 for a vehicle to which the present invention is applied will be described below with reference to FIGS. 1 and 2. FIG. 1 is a schematic structural view showing a head-up display device 1000 in accordance with an embodiment of the present invention. FIG. 2 is a schematic cross-sectional view showing a display unit of the head-up display device 1000 in this embodiment.

A head-up display device 1000 includes, as shown in FIG. 1, a display device 102 provided in an inside of an instrument panel 101 of a vehicle 100, and a display light “L” projected by the display device 102 is reflected by a windshield 103 that is a projection member toward a driver 104 of the vehicle 100 to display a virtual image (display image) “V”. In other words, the head-up display device 1000 is structured so that a display light “L” emitted from a liquid crystal display 110 described below of the display device 102 is radiated (projected) to the windshield 103 and a virtual image “V” obtained by the radiation is visually recognized by the driver 104. In this manner, the driver 104 is capable of observing the virtual image “V” superposed on a landscape.

The display device 102 includes, as shown in FIG. 2, the liquid crystal display 110, a first reflector 120, a second reflector 130 and a housing 140.

The liquid crystal display 110 includes a light source 111 and a liquid crystal display element (display element) 112. The light source 111 is structured of light emitting diodes mounted on a wiring circuit board “R”. The liquid crystal display element 112 is a thin film transistor (TFT) type liquid crystal display element which is located on a front side (upper side) of the light source 111 so as to transmit an illumination light from the light source 111 to form a display light “L”. The liquid crystal display element 112 displays information to be displayed (for example, a speed and an engine speed of a vehicle 100) with a numerical value or the like by light emission through lights emitted from the light source 111 disposed on a rear side (lower side) based on a drive signal from an element drive circuit not shown. In this case, information to be displayed is not limited to a speed and an engine speed of a vehicle 100, and a display form is not limited to indication of a numerical value and any form may be adopted. The liquid crystal display 110 is structured to output a display light “L” comprised of light in a visible wavelength range. For example, a light source 111 which emits red light (mainly, light emitting wavelength range 610-640 nm) can be used.

The liquid crystal display 110 is provided in an inside of a housing 140 so that its face on an emitting side of the display light “L” faces a cold mirror 121 described below of the first reflector 120, and the liquid crystal display 110 is fixed and held at a position and in a posture so that an optical axis of the display light “L” intersects the cold mirror 121.

The first reflector 120 includes the cold mirror 121 and an attaching member 122 for fixing the cold mirror 121 to the housing 140. The cold mirror 121 reflects the display light “L” emitted from the liquid crystal display 110 toward the second reflector 130 (concave mirror 131). The cold mirror 121 includes a glass substrate 121a formed in a substantially rectangular shape and a first reflection layer 121b consisting of multilayered interference films whose film thicknesses are different and which are formed on one face of the glass substrate 121a (face opposed to a concave mirror 131 described below of the second reflector 130) by vapor deposition or the like. Further, the attaching member 122 is, for example, made of black synthetic resin material and is fixed to the housing 140.

In this embodiment, the cold mirror 121 is structured so that light in a visible wavelength range (450-750 nm) including a light emitting wavelength range of the liquid crystal display 110 is reflected with a high reflectance (for example, 80% or more) and that light other than the visible wavelength range is reflected with a low reflectance. In this case, as the cold mirror 121, a mirror which reflects light other than a visible wavelength range, especially, light in an infrared wavelength region (infrared rays or heat rays of sunlight) with a low reflectance (for example, 15% or less) is used. Light which is not reflected by the first reflection layer 121b is transmitted through the cold mirror 121. In this embodiment, the cold mirror 121 is, similarly to the liquid crystal display 110, disposed at a position unable to be directly seen through a translucent cover 144 described below of the housing 140 and light (external light) from the outside such as sunlight is not directly incident.

The second reflector 130 includes a concave mirror 131 and a mirror holder 132 which holds the concave mirror 131. The concave mirror 131 includes a second reflection layer 131a vapor-deposited on a concave surface of a resin substrate made of polycarbonate. The concave mirror 131 is structured so that the display light “L” from the cold mirror 121 (i.e., liquid crystal display element 112) is enlarged and reflected toward the windshield 103 through the translucent cover 144 of the housing 140. The concave mirror 131 is disposed so that the second reflection layer 131a faces the cold mirror 121 and the translucent cover 144 of the housing 140 and is disposed at a position visible from the translucent cover 144.

The mirror holder 132 is made of synthetic resin material and is provided with a turnable shaft “S” which is supported by a bearing part provided in the housing 140 and is perpendicular to an optical axis of the display light “L”. In other words, the mirror holder 132 and the concave mirror 131 held by the mirror holder 132 are turnable with the turnable shaft “S” as a center and, as a result, an angular position of the mirror holder 132, in other words, a projection direction of the display light “L” can be adjusted. The mirror holder 132 is formed with a protruded piece 132a which is partly protruded toward an outer side in a radial direction of the turnable shaft “S”. The protruded piece 132a is moved by a drive force of a drive device 1 and thereby the mirror holder 132 is turned. A detailed structure of the drive device 1 will be described below.

The housing 140 is, for example, formed of aluminum diecasting and includes an upper side case body 141 and a lower side case body 142 whose cross sections are formed in a substantially “U”-shape. The upper side case body 141 and the lower side case body 142 form an inside space 143. The liquid crystal display 110, the first reflector 120 and the second reflector 130 are accommodated in the inside space 143.

The upper side case body 141 is formed with an opening part 141a at a position facing the concave mirror 131, and the translucent cover 144 is disposed so as to close the opening part 141a. The translucent cover 144 is made of translucent synthetic resin material (for example, acrylic resin) and is provided with a function as a light transmissive member which transmits (pass) the display light “L” reflected by the concave mirror 131. In other words, the display light “L” reflected by the concave mirror 131 is projected to the windshield 103 through the translucent cover 144 provided in the housing 140 to display a virtual image “V”.

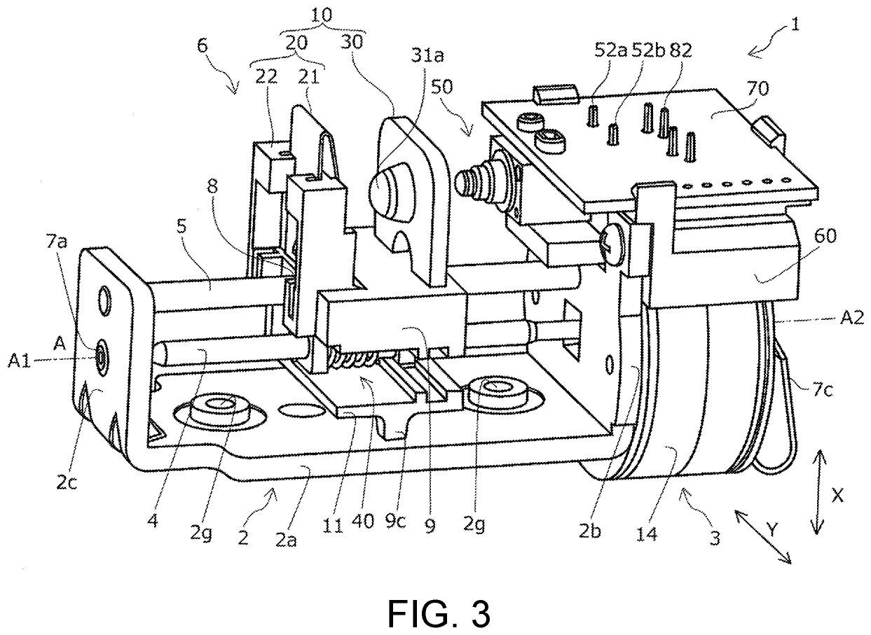

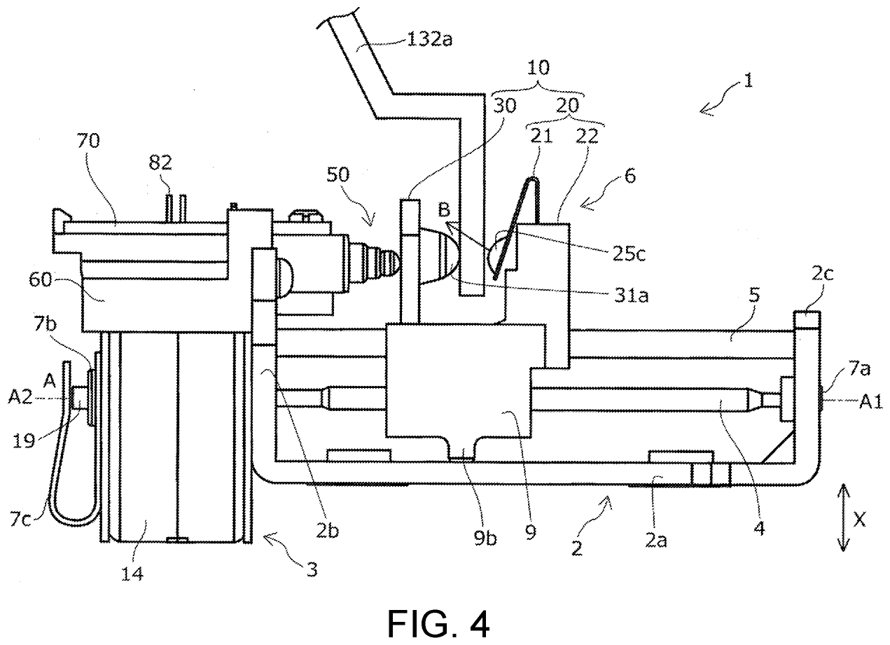

Next, the drive device 1 in this embodiment will be described below with reference to FIGS. 3 and 4. FIG. 3 is a schematic perspective view showing the drive device 1 in this embodiment and FIG. 4 is a schematic side view showing the drive device 1 in this embodiment in which the protruded piece 132a of the mirror holder 132 as the supported member is supported. In the following descriptions, in a direction where an axial line “A” of a lead screw 4 (shaft 19) is extended, one side where the lead screw 4 is protruded is referred to as an output side “A1”, and an opposite side (the other side) to the side where the lead screw 4 is protruded is referred to as an opposite-to-output side “A2”. Further, a direction in which support parts 2b and 2c of a frame 2 are extended with respect to the axial line “A” direction is referred to as an “X” direction, and a direction perpendicular to the “X” direction and the axial line “A” direction is referred to as a “Y” direction.

The drive device 1 includes the lead screw 4 whose outer peripheral face is formed with a spiral groove, a drive part 3 structured to rotationally drive the lead screw 4 around the axial line “A”, a movable member 6 which is engaged with the spiral groove and is moved in the axial line “A” direction, and a frame 2 which supports the drive part 3 and the like. The frame 2 is fixed with a guide shaft 5 which is disposed in parallel to the lead screw 4 along the axial line “A” direction. The drive part 3 is a motor such as a stepping motor, which is generally structured of a stator 14 structuring a motor case and a rotor (not shown) disposed in an inside of the stator 14. The rotor includes a shaft 19 and a permanent magnet (not shown) fixed to the shaft 19.

The stator 14 is fixed to the support part 2b of the frame 2 on the opposite-to-output side “A2” in the axial line “A” direction by welding or the like. A circuit board holder 60 which holds a power feeding circuit board 70 is fixed to the support part 2b by a bolt.

Terminal pins 82 as a power feeding part are provided in a side face of the stator 14 and are electrically connected with the power feeding circuit board 70. An end portion (not shown) of a drive coil of the stator 14 is wound around the terminal pin 82, and the power feeding circuit board 70 and the drive coil are electrically connected with each other by soldering the terminal pin 82 to the power feeding circuit board 70.

A switch unit 50 is attached to the power feeding circuit board 70. The switch unit 50 is a pressing type switch structured to detect a home position in a moving direction (axial line “A” direction) of the movable member 6. Electric connection of the switch unit 50 with the power feeding circuit board 70 is performed by soldering terminal pins 52a and 52b of the switch unit 50 with the power feeding circuit board 70.

The frame 2 is provided with a plate-shaped frame main body 2a and a pair of support parts 2b and 2c which are formed by bending both ends in a longitudinal direction of the frame main body 2a. The frame 2 is fixed to the housing 140 by utilizing a hole 2g formed in the frame main body 2a. The drive part 3 is fixed to the support part 2b on the opposite-to-output side “A2” in the axial line “A” direction.

The lead screw 4 is integrally formed with the shaft 19 of the drive part 3 and is structured by forming a spiral groove on an outer peripheral face in a part of the shaft 19 (portion which is protruded to the output side “A1” in the axial line “A” direction from the stator 14). Therefore, the lead screw 4 is driven and rotated by the drive part 3. The lead screw 4 is disposed in a substantially parallel to the frame main body 2a. A tip end of the lead screw 4 on the output side “A1” in the axial line “A” direction is turnably supported by a bearing 7a which is provided in the support part 2c of the frame 2 on the output side “A1” in the axial line “A” direction. Further, an end part of the shaft 19 on the opposite-to-output side “A2” in the axial line “A” direction is turnably supported by a bearing 7b attached to the drive part 3. A tip end of the shaft 19 is urged by an urging member 7c made of a plate spring to the output side “A1” in the axial line “A” direction. The guide shaft 5 is disposed in parallel to the lead screw 4 and the both ends are respectively fixed to the support parts 2b and 2c of the frame 2. In this embodiment, the guide shaft 5 and the lead screw 4 are disposed so as to be overlapped with each other in the “X” direction.

The movable member 6 includes a nut unit 40 which is engaged with the lead screw 4 and is moved in the axial line “A” direction, a main body part 9 which is integrally moved in the axial line “A” direction together with the nut unit 40, and a support part 10 which is provided on an upper side of the main body part 9 and supports the protruded piece 132a of the mirror holder 132 that is a supported member. The main body part 9 is formed with a guide hole 8 through which the guide shaft 5 is penetrated and a nut arrangement part 11 where the nut unit 40 is disposed. The movable member 6 is reciprocated in the axial line “A” direction in a state that the movable member 6 is guided by the guide shaft 5 when the nut unit 40 is reciprocated in the axial line “A” direction accompanied with rotation of the lead screw 4 by the drive part 3. As a result, when the protruded piece 132a is reciprocated in the axial line “A” direction, the mirror holder 132 is turned to a predetermined angle with the turnable shaft “S” (see FIG. 2) as a center.

(Support Part)

The support part 10 includes an elastic support part 20 which urges the protruded piece 132a of the mirror holder 132 to the opposite-to-output side “A2” in the axial line “A” direction, and a fixed support part 30 which is provided so as to face the elastic support part 20 on the opposite-to-output side “A2” in the axial line “A” direction and support the protruded piece 132a urged by the elastic support part 20. In other words, the elastic support part 20 and the fixed support part 30 are provided so as to face the protruded piece 132a and, since the protruded piece 132a is always pressed against the fixed support part 30 by an elastic force of the elastic support part 20, even when vibration or the like occurs, positioning accuracy of the protruded piece 132a can be enhanced. According to this structure, the protruded piece 132a is supported in a state that the protruded piece 132a is always pressed against the fixed support part 30 by the elastic support part 20. Therefore, a position of the protruded piece 132a can be always determined with the fixed support part 30 as a reference and, for example, even when movement or vibration occurs, the position of the protruded piece 132a is hard to be displaced. In addition, even when the vehicle is vibrated, rattling of the protruded piece 132a is restrained by the urging force of the elastic support part 20 and thus a display image can be suppressed from generating a blur. In this manner, the support part 10 in this embodiment is capable of enhancing the positional accuracy of the protruded piece 132a of the mirror holder 132.

The elastic support part 20 includes an elastic member 21 which is abutted with the protruded piece 132a of the mirror holder 132 to urge the protruded piece 132a toward the fixed support part 30, and an elastic member fixing part 22 to which the elastic member 21 is fixed. The elastic member fixing part 22 is made of synthetic resin material such as polyacetal and is integrally formed with the main body part 9. In this case, it may be structured that the elastic member fixing part 22 is separately formed from the main body part 9 and is fixed to the main body part 9 by adhesion or the like.

The fixed support part 30 is made of metal such as stainless steel and is formed of material having higher rigidity than the main body part 9 made of resin. The fixed support part 30 is integrally formed with the main body part 9 by insert molding. Therefore, the fixed support part 30 is partly embedded and fixed to the main body part 9. According to this structure, in comparison with a case that the fixed support part 30 is integrally formed with the main body part 9 by using resin, strength of the fixed support part 30 can be increased. As a result, a resonance frequency of the entire head-up display device 1000 can be increased, generation of a resonance due to vibration of a vehicle is restrained, and a blur can be suppressed from being generated in a display image.

(Elastic Support Part)

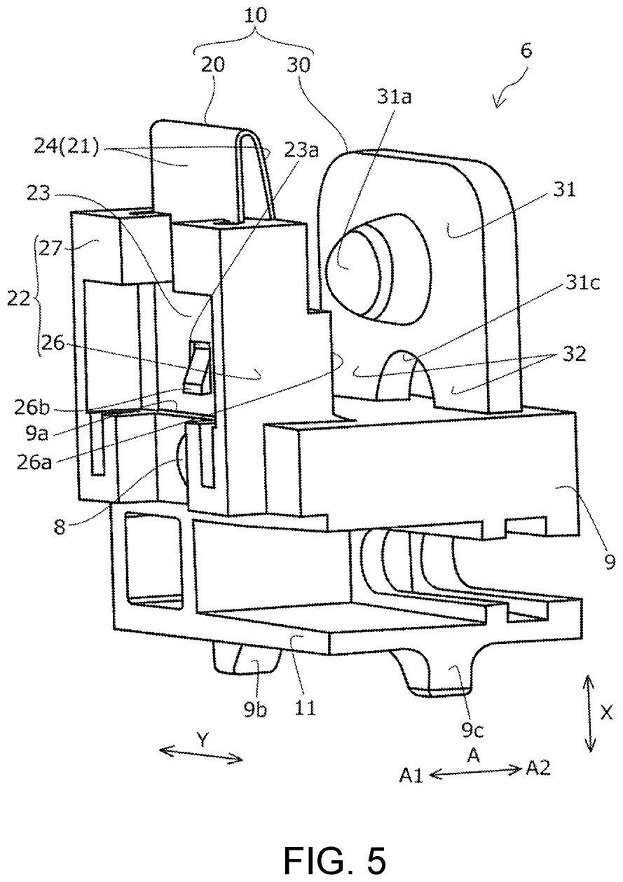

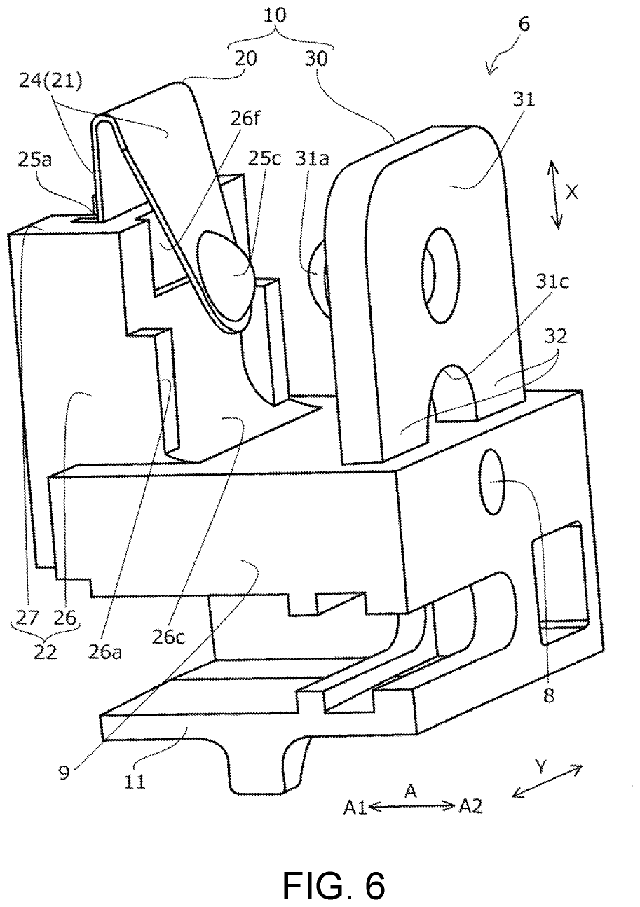

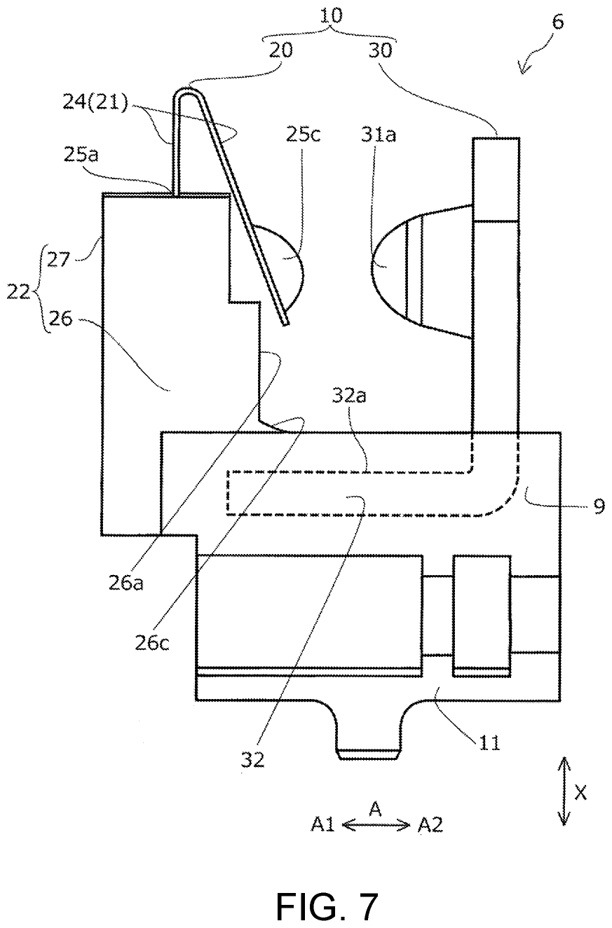

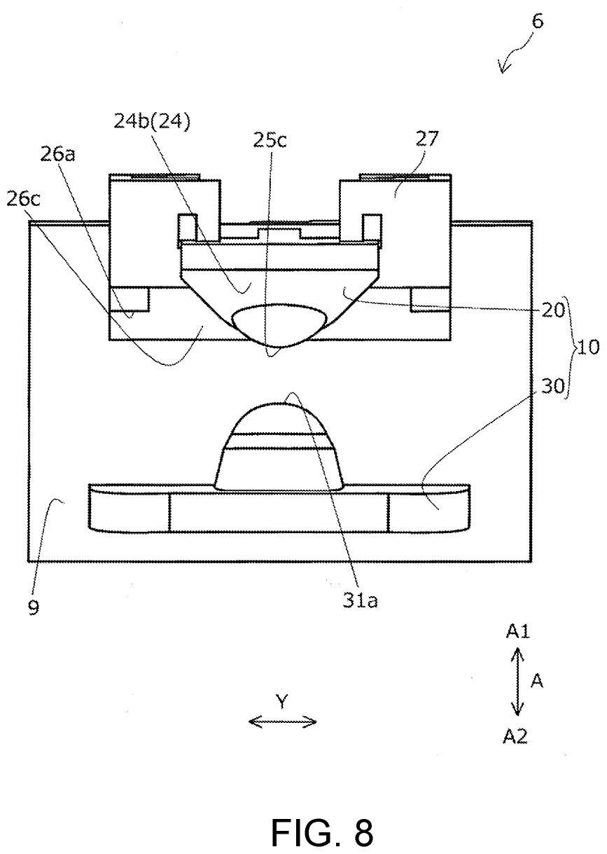

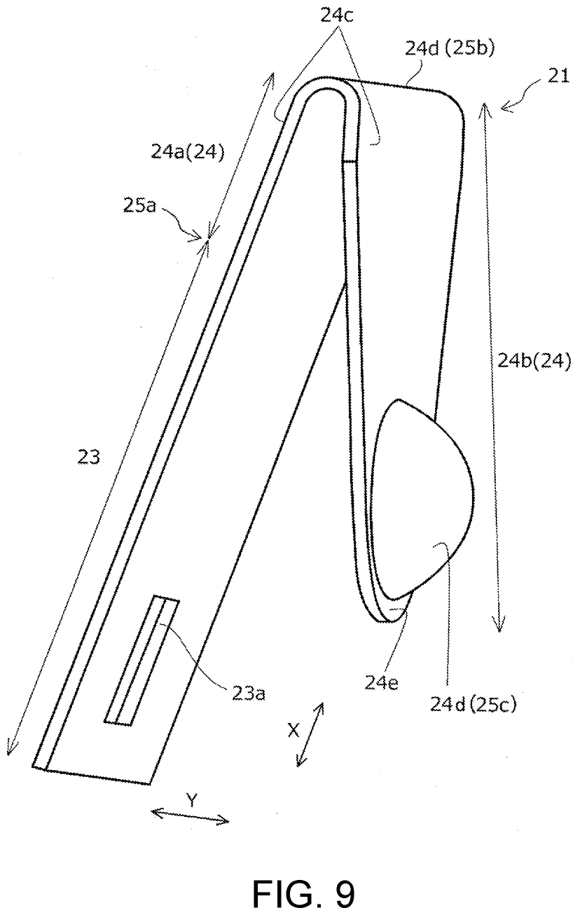

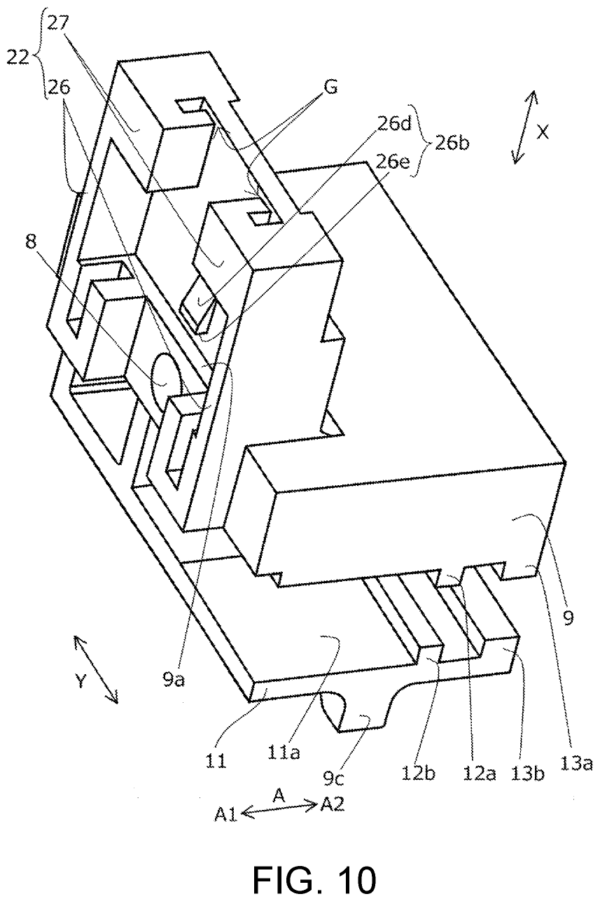

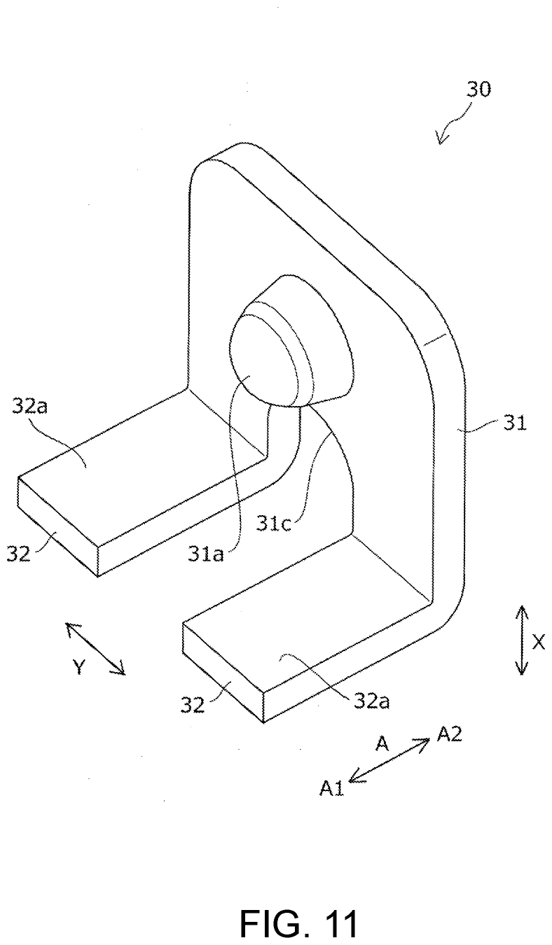

A detailed structure of the elastic support part 20 in this embodiment will be described below with reference FIGS. 5 through 11. FIGS. 5 and 6 are schematic enlarged perspective views showing the movable member 6 in this embodiment. Further, FIG. 7 is a schematic enlarged side view showing the movable member 6 in this embodiment and FIG. 8 is a schematic enlarged plan view showing the movable member 6 in this embodiment. In FIGS. 5 through 8, a nut unit is not shown for a simple description. FIG. 9 is a schematic perspective view showing the elastic member 21 in this embodiment. FIG. 10 is a schematic perspective view showing the elastic member fixing part 22 and the like in this embodiment. In FIG. 10, the fixed support part 30 is not shown for a simple description. FIG. 11 is a schematic perspective view showing the fixed support part 30 in this embodiment.

The elastic member 21 is, as shown in FIG. 5, provided with a fixed plate part 23 which is attached and fixed to the elastic member fixing part 22, and an elastically deformable plate part 24 which is extended from an end part of the fixed plate part 23 and is elastically deformable. The elastic member 21 in this embodiment is a plate spring having a relatively wide width (length in the “Y” direction). Since the elastic member 21 is a plate spring, the elastic member 21 can be easily fixed to the elastic member fixing part 22.

The fixed plate part 23 is formed with a first engaging part 23a which is engaged with a second engaging part 26b of the elastic member fixing part 22, and the first engaging part 23a in this embodiment is an opening part which is long in the “X” direction (see FIG. 9). The elastically deformable plate part 24 is structured of a first elastic part 24a which is extended from an end part of the fixed plate part 23 and a second elastic part 24b which is obliquely extended from an end part of the first elastic part 24a to the opposite-to-output side “A2” in the axial line “A” direction. The first elastic part 24a is extended on an extended line of the fixed plate part 23 (“X” direction in which the fixed plate part 23 is extended), and the second elastic part 24b is extended at an acute angle with respect to the first elastic part 24a. A first supporting point part 25a is formed between the fixed plate part 23 and the first elastic part 24a. The first supporting point part 25a is, as shown in FIG. 6, determined as a contact part of the elastic member 21 with an upper end of the elastic member fixing part 22. In other words, the first supporting point part 25a is determined as a boundary part between a region where the elastic member 21 is held by the elastic member fixing part 22 and a region where the elastic member 21 is not held by the elastic member fixing part 22. The first elastic part 24a is elastically deformable with respect to the fixed plate part 23 with the first supporting point part 25a as a supporting point. Further, a second supporting point part 25b which is a bent part of the elastically deformable plate part 24 is formed between the first elastic part 24a and the second elastic part 24b, and the second elastic part 24b is capable of being elastically deformed with respect to the first elastic part 24a with the second supporting point part 25b as a supporting point. Since structured as described above, the elastic support part 20 in this embodiment secures elasticity of the elastically deformable plate part 24 and easily forms the elastically deformable plate part 24.

In addition, as shown in FIG. 9 and the like, the second elastic part 24b of the elastically deformable plate part 24 is provided at its tip end part with an elastic support part side protruded part 25c as an abutting part which is protruded toward a side to be abutted with the protruded piece 132a of the mirror holder 132. The elastic support part side protruded part 25c is abutted with the protruded piece 132a. The elastic support part side protruded part 25c in this embodiment is structured of a convex curved face in a hemispherical shape. In this case, it is sufficient that the elastic support part side protruded part 25c is formed in a shape so that the protruded piece 132a is not caught, the protruded piece 132a is smoothly moved, the protruded piece 132a is not damaged and a posture of the protruded piece 132a is changeable. For example, instead of a convex curved face, the elastic support part side protruded part 25c may be formed in a shape that only a portion to be abutted with the protruded piece 132a is chamfered, a needle-like shape, a conic shape or a polygonal pyramid shape. However, when the elastic support part side protruded part 25c is structured of a convex curved face, the elastic support part side protruded part 25c can be easily formed. A fixed support part side protruded part 31a described below is also structured of a convex curved face in a hemispherical shape similarly to the elastic support part side protruded part 25c, and it is preferable that the fixed support part side protruded part 31a is provided with similar features to the elastic support part side protruded part 25c.

The convex curved face of the elastic support part side protruded part 25c is formed by partly pushing out a plate spring by press or the like. Further, as shown in FIG. 9, the elastically deformable plate part 24 is provided with a plate-shaped portion 24c and a convex curved face 24d which is protruded in a hemispherical shape at a tip end of the plate-shaped portion 24c. Further, as shown in FIG. 9, a plate-shaped portion 24e is formed around the elastic support part side protruded part 25c. In a case that the elastic support part side protruded part 25c is a convex curved face, even when the protruded piece 132a of the mirror holder 132 is inclined, the protruded piece 132a can be urged toward the fixed support part 30 side while preventing displacement, abrasion and noise of the abutting part.

In the drive device 1 in this embodiment, as shown in FIG. 4, an abutting direction “B” of the elastic support part side protruded part 25c with respect to the protruded piece 132a is deviated from the axial line “A” direction which is a direction toward a position of the fixed support part side protruded part 31a. Specifically, although a direction toward the position of the fixed support part side protruded part 31a is a horizontal direction, the abutting direction “B” is deviated upward with respect to the horizontal direction. When the movable member 6 is moved, a height of the elastic support part protruded part 25c is slightly varied with respect to the fixed support part side protruded part 31a. Therefore, in a case that the abutting direction “B” is set in the same direction as the direction toward the position of the fixed support part side protruded part 31a, when the height is varied to an opposite side (for example, from the lower side to the upper side, or from the upper side to the lower side) with respect to a center of the fixed side support part protruded part 31a by movement of the movable member 6, a direction of a force applied to the fixed side support part protruded part 31a is changed to an opposite side. On the other hand, in a case that it is originally structured that a force is applied to a direction deviated from the point contacted position, even when a direction of a force to be applied is deviated to some extent, it can be restrained that the direction of the force to be applied is changed to an opposite side. Therefore, in the drive device 1 in this embodiment, the abutting direction “B” is deviated from the direction toward the position of the fixed support part side protruded part 31a and thus, even when vibration or the like occurs accompanied with movement of the movable member 6, it can be restrained that the direction of the force to be applied is changed to an opposite side with the fixed side support part protruded part 31a as a reference.

The elastic member fixing part 22 is, as shown in FIG. 10 and the like, provided with a protruded part 26 protruded in the “X” direction from the main body part 9 and a pair of restriction parts 27 which are provided at a tip end in the protruding direction (“X” direction) of the protruded part 26 and at the both ends in its width direction (“Y” direction). Reinforcing ribs 26a which connect the protruded part 26 with the main body part 9 are provided on the main body part 9 side of the protruded part 26. The reinforcing rib 26a is provided for reinforcing the weakest portion in the strength when a load is applied to the elastic member fixing part 22. Further, the reinforcing rib 26a is structured so as to be capable of abutting with the protruded piece 132a of the mirror holder 132. When the mirror holder 132 is inclined to a side of the fixed support part 30, the elastic member 21 is pushed to a side of the elastic member fixing part 22 by the protruded piece 132a. In this case, in this embodiment, the protruded piece 132a is abutted with the reinforcing rib 26a and thus, a movement amount of the protruded piece 132a is restricted and excessive deformation of the elastic member 21 is restrained. Therefore, it can be restrained that the elastic member 21 deforms excessively and comes off from the elastic member fixing part 22. In other words, the elastic member fixing part 22 is provided with the reinforcing rib 26a as a moving range restriction part which restricts a moving range of the elastic member 21.

Further, as shown in FIG. 6, an inclined face part 26c whose width becomes wider in the axial line “A” direction is formed toward the main body part 9 side on the opposite-to-output side “A2” of the protruded part 26. In this embodiment, a load is applied to the elastic member fixing part 22 from the opposite-to-output side “A2” toward the output side “A1” in the axial line “A” direction. In this case, a portion which is the weakest in the strength and the easiest to be broken is a root portion on the opposite-to-output side “A2” of the protruded part 26. The reinforcing ribs 26a and the inclined face part 26c are provided in this portion to reinforce in the direction (axial line “A” direction) where a load is applied. As shown in FIG. 6, the inclined face part 26c in this embodiment is curved toward a lower side (main body part 9 side). However, the inclined face part 26c may be formed to be wider in a straight line shape.

A pair of the restriction parts 27 is formed on a face on the output side “A1” in the axial line “A” direction of the protruded part 26. A gap space “G” is formed between the restriction part 27 and the face of the protruded part 26 so as to have substantially the same distance as the thickness of the elastic member 21 and into which the elastic member 21 is inserted (see FIG. 10). Each of the restriction parts 27 restricts movement in the “Y” direction of the fixed plate part 23 of the elastic member 21 inserted into the gap space “G” and restricts movement in the axial line “A” direction of the fixed plate part 23. In this manner, the elastic member 21 is attached to the elastic member fixing part 22 in a state that movements in directions (“Y” direction and axial line “A” direction) intersecting an inserting direction of the fixed plate part 23 inserted into the gap space “G” are restricted, in other words, positional displacement of the elastic member 21 is restrained.

In addition, a second engaging part 26b which is engaged with the first engaging part 23a formed in the fixed plate part 23 is formed on a face on the output side “A1” in the axial line “A” direction of the protruded part 26. The second engaging part 26b is formed in a so-called snap-fitting shape and is, as shown in FIG. 10, provided with a guide face 26d on an upper side in the “X” direction, which is inclined with respect to a face of the protruded part 26 on the output side “A1” in the axial line “A” direction, and an engaging face 26e on a lower side in the “X” direction which is substantially perpendicular to the face of the protruded part 26 on the output side “A1” in the axial line “A” direction. When the fixed plate part 23 is inserted into the gap space “G” and the first engaging part (opening part) 23a is engaged with the engaging face 26e, movement in the “X” direction of the fixed plate part 23 can be also restricted and coming-off of the fixed plate part 23 can be prevented. In this embodiment, an upper face part 9a of the main body part 9 serves as a restriction part on a lower side in the “X” direction with respect to the fixed plate part 23. Further, when the fixed plate part 23 is inserted and fixed to the gap space “G”, the boundary part between the region where the elastic member 21 is held by the elastic member fixing part 22 and the region where the elastic member 21 is not held by the elastic member fixing part 22 becomes the first supporting point part 25a described above.

As shown in FIG. 6, a face of the protruded part 26 on the opposite-to-output side “A2” in the axial line “A” direction is formed with a stepped part 26f at a tip end in the “X” direction. The stepped part 26f has a width (length in the “Y” direction) wider than a width of the second elastic part 24b of the elastically deformable plate part 24. As a result, the stepped part 26f functions as a relief part which avoids an interference with the second elastic part 24b of the elastically deformable plate part 24 and thus, a movable range of the elastically deformable plate part 24 can be increased. In other words, the stepped part 26f is located at an edge part of the protruded part 26 which faces the second elastic part 24b and, when the elastically deformable plate part 24 is resiliently bent, the second elastic part 24b is not abutted with the edge part.

In the embodiment described in the drawing, the elastic member 21 is attached to the face on the output side “A1” in the axial line “A” direction of the elastic member fixing part 22. However, the elastic member 21 may be attached to the face on the opposite-to-output side “A2” in the axial line “A” direction, and its attaching method is not limited to the snap fitting method described in the drawing and, for example, a screw or an adhesive may be used. Further, it is sufficient that the elastic member 21 urges the protruded piece 132a of the mirror holder 132 toward the fixed support part 30. Therefore, the elastic member 21 is not limited to a plate spring. For example, another spring member such as a coil spring may be utilized and, alternatively, a member structured of material having elasticity such as rubber may be used.

(Fixed Support Part)

Next, a detailed structure of the fixed support part 30 in this embodiment will be described below with reference to FIGS. 5 through 11.

The fixed support part 30 is, as shown in FIGS. 5, 6 and 11, provided with a support main body part 31 and a pair of extended parts 32. The support main body part 31 and a pair of the extended parts 32 are extended in the “X” direction and then extended in the axial line “A” direction. As shown in FIG. 7, at least upper faces 32a of the extended parts 32 are covered with the main body part 9 and thereby the support main body part 31 is held. As a result, coming-off of the fixed support part 30 in the “X” direction from the main body part 9 can be surely prevented.

The support main body part 31 is formed with a fixed support part side protruded part 31a which is protruded toward the elastic support part 20 facing on the output side “A1” in the axial line “A” direction. The protruded piece 132a of the mirror holder 132 urged by the elastic support part 20 is supported by the fixed support part side protruded part 31a. The fixed support part side protruded part 31a is formed in a hemispheric shape. Since the fixed support part side protruded part 31a and the above-mentioned elastic support part side protruded part 25c are structured in the shapes as described above, even when an inclination of the protruded piece 132a of the mirror holder 132 is largely varied (even when the posture is largely varied), the protruded piece 132a can be surely supported without being damaged. However, the fixed support part side protruded part 31a and the elastic support part side protruded part 25c are not limited to the shapes in the drawing.

As described above, in the drive device 1 in this embodiment, the protruded piece 132a is supported by the elastic support part side protruded part 25c which is a convex curved face provided in the elastic support part 20 and the fixed support part side protruded part 31a which is a convex curved face provided in the fixed support part 30. In other words, the supported member can be sandwiched and supported by the protruded parts which are convex curved faces and thus, positioning accuracy of the supported member can be enhanced. In addition, since the fixed support part side protruded part 31a which is one of the protruded parts is provided in the fixed support part 30, rattling of the supported member can be also suppressed. Further, in a case that the above-mentioned structure is adopted, when the supported member is to be inserted into a sandwiching position of the protruded parts, the supported member can be easily inserted from an upper side (“X” direction) and, in addition, also from a lateral direction (“Y” direction). Further, in the drive device 1 in this embodiment structured as described above, a degree of freedom of a support posture of the supported member can be also enhanced. In this case, the phrase of “a degree of freedom of a support posture of the supported member can be enhanced” means that the supported member can be supported at various angles. For example, the protruded piece 132a of the mirror holder 132 as a supported member may be supported in parallel to the “Y” direction, or may be supported in a direction inclined with respect to the “Y” direction.

The main body part 9 is formed with a guide hole 8 into which the guide shaft 5 for guiding movement of the movable member 6 is fitted. A pair of the extended parts 32 is disposed in the main body part 9 so as not to overlap with the guide hole 8. The support main body part 31 is formed with a cut-out part 31c and is disposed so that the cut-out part 31c and the guide hole 8 are overlapped with each other in the axial line “A” direction. Therefore, the pair of the extended parts 32 are divided into two portions by the cut-out part 31c in the “Y” direction and are disposed so as to avoid the guide hole 8. In this manner, the extended parts 32 are effectively disposed in a limited space and coming-off of the fixed support part 30 can be effectively prevented. In this embodiment, only one extended part 32 may be provided.

In this embodiment, the entire width of the extended parts 32 in the “Y” direction (length from one end part to the other end part in the “Y” direction) is the same as that of the support main body part 31. The extended parts 32 are arranged as described above and thus contact areas of the extended parts 32 with the main body part 9 can be increased and the fixed support part 30 can be further firmly held. As a result, coming-off of the fixed support part 30 can be further surely prevented.

(Nut Unit)

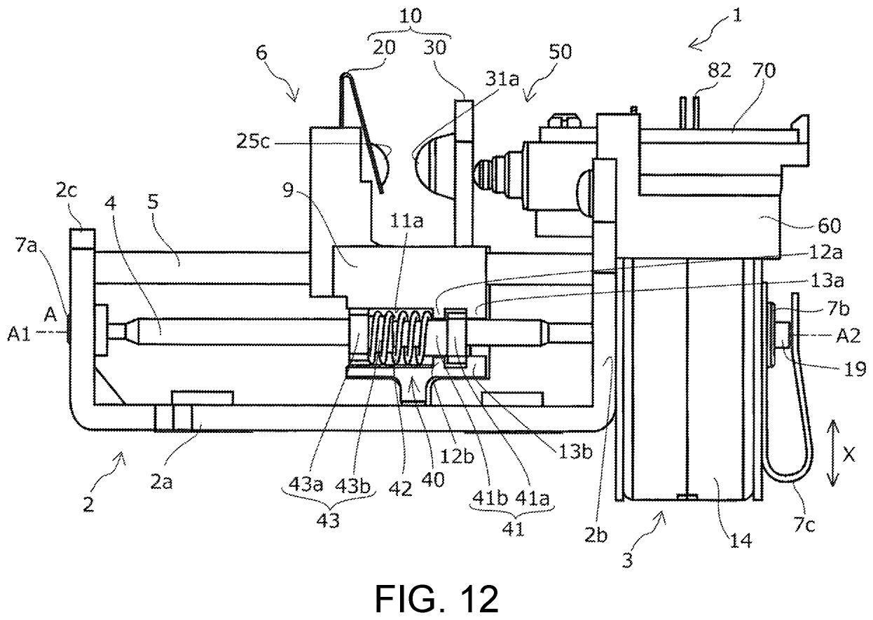

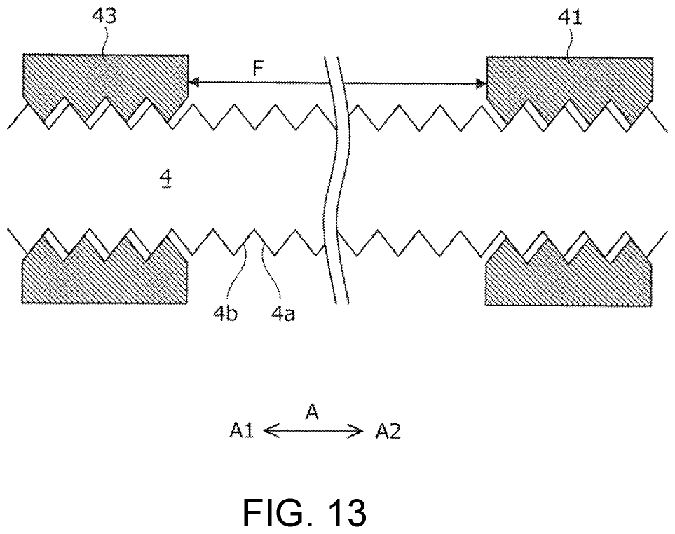

Next, a detailed structure of a nut unit 40 used in the drive device 1 in this embodiment will be described below with reference to FIGS. 12 and 13. FIG. 12 is a schematic side view showing the drive device 1 in this embodiment which is viewed from an opposite side to FIG. 4, and FIG. 13 is a schematic view for explaining operation of a nut unit 40 in this embodiment. The drive device 1 in this embodiment includes a nut unit 40 structured as described below and thus, rattling in a moving direction of the movable member 6 (axial direction of the lead screw 4) can be suppressed and a space of the device can be saved and the device can be simplified. However, the present invention is not limited to the drive device 1 having the nut unit 40 described below.

The nut unit 40 includes a first nut member 41 structuring a first threaded part, a coil spring 42, and a second nut member 43 structuring a second threaded part. The nut unit 40 is disposed in a groove-shaped nut arrangement part 11 formed in the main body part 9. The first nut member 41 and the second nut member 43 are threadedly engaged with the lead screw 4, and the lead screw 4 penetrates through an inside of the coil spring 42.

The first nut member 41 is provided with a flange part 41a whose outward shape is rectangular and a tube part 41b extended from the flange part 41a in the axial line “A” direction. A threaded part which is threadedly engaged with the lead screw 4 is formed on inner sides of the flange part 41a and the tube part 41b. The second nut member 43 is also provided with a flange part 43a whose outward shape is rectangular and a tube part 43b extended from the flange part 43a in the axial line “A” direction. A threaded part which is threadedly engaged with the lead screw 4 is formed on inner sides of the flange part 43a and the tube part 43b. The first nut member 41 and the second nut member 43 are disposed in the nut arrangement part 11 so that the tube parts 41a and 43a are faced each other. The flange part 41a of the first nut member 41 is abutted with a pair of opposed ribs 12a and 12b which are protruded from an inner face 11a of the nut arrangement part 11. In this embodiment, another pair of opposed ribs 13a and 13b is formed on the inner face 11a of the nut arrangement part 11 on the opposite-to-output side “A2” in the axial line “A” direction with respect to the first nut member 41. The opposed ribs 13a and 13b are provided for easily positioning the nut unit 40 (first nut member 41) and the movable member 6.

The coil spring 42 is disposed between the pair of the opposed ribs 12a and 12b and the second nut member 43 in a compressed state. Therefore, the coil spring 42 is abutted with the pair of the opposed ribs 12a and 12b on one end part to urge the pair of the opposed ribs 12a and 12b to the opposite-to-output side “A2” in the axial line “A” direction so that the opposed ribs 12a and 12b are abutted with the flange part 41a of the first nut member 41. Further, the other end part of the coil spring 42 is abutted with the flange part 43a of the second nut member 43 to urge the flange part 43a of the second nut member 43 to the output side “A1” in the axial line “A” direction. In this embodiment, another pair of the opposed ribs 13a and 13b are provided and thus, when the nut unit 40 is to be arranged in the nut arrangement part 11, a distance between the pair of the opposed ribs 12a and 12b and the second nut member 43 can be restrained from becoming too small. Therefore, the coil spring 42 can be restrained from being excessively compressed and from being disengaged from the tube part 41b of the first nut member 41.

The flange part 41a of the first nut member 41 is abutted with an inner face 11a of the nut arrangement part 11 and thereby turning of the first nut member 41 with respect to the main body part 9 is restricted. In other words, the inner face 11a of the nut arrangement part 11 functions as a restriction part which is abutted with the flange part 41a of the first nut member 41 to restrict turning of the first nut member 41. In addition, the first nut member 41 is, as described above, applied with an urging force (pressurization) by the coil spring 42 toward the opposite-to-output side “A2” in the axial line “A” direction through the pair of the opposed ribs 12a and 12b, and the flange part 41a is always abutted with the pair of the opposed ribs 12a and 12b. Therefore, the first nut member 41 functions as a drive force transmission part structured to transmit a drive force of the drive part 3 to the main body part 3, and the pair of the opposed ribs 12a and 12b functions as a drive force receiving part structured to receive the drive force of the drive part 3 from the first nut member 41. As a result, the main body part 9 can be reciprocated in the axial line “A” direction accompanied with rotation of the lead screw 4.

The flange part 43a of the second nut member 43 is abutted with the inner face 11a of the nut arrangement part 11 and thereby turning of the second nut member 43 with respect to the main body part 9 is restricted. In other words, the inner face 11a of the nut arrangement part 11 functions as a restriction part which is abutted with the flange part 43a of the second nut member 43 to restrict turning of the second nut member 43. On the other hand, the second nut member 43 is not supported by the main body part 9 in the axial line “A” direction and, as described above, the second nut member 43 is applied with an urging force (pressurization) toward the output side “A1” in the axial line “A” direction by the coil spring 42. In this manner, the second nut member 43 functions as a pressurization applying part together with the coil spring 42 and, as shown in FIG. 13, pressurization “F” can be applied between the threaded part of the first nut member 41 and the threaded part of the second nut member 43 in a separated direction from each other.

When the movable member 6 is to be moved by the first nut member 41, the threaded part of the first nut member 41 can be always abutted with a flank surface 4a (see FIG. 13) on the opposite-to-output side of the lead screw 4 by the pressurization “F”. In addition, the threaded part of the second nut member 43 can be abutted with a flank surface 4b (see FIG. 13) on the output side of the lead screw 4. As a result, clearance (backlash) between the lead screw 4 and the respective nut members (threaded parts) is absorbed and rattling in the moving direction (axial line “A” direction) of the movable member 6 can be suppressed.

As described above, one end part of the coil spring 42 is abutted with the movable member 6 (the pair of the opposed ribs 12a and 12b), and the other end part of the coil spring 42 is abutted with the second nut member 43, and the movable member 6 is abutted with the flange part 41a of the first nut member 41. Therefore, when the movable member 6 is to be moved to the output side “A1” in the axial line “A” direction, a moving force of the first nut member 41 is transmitted as a drive force to the movable member 6 through the flange part 41a and, when the movable member 6 is to be moved to the opposite-to-output side “A2” in the axial line “A” direction, the drive force by the urging force of the coil spring 42 is transmitted to the movable member 6 through the first nut member 41. In this manner, the movable member 6 can be moved to both of the output side “A1” and the opposite-to-output side “A2” in the axial line “A” direction and, also in these cases, as described above, rattling of the movable member 6 can be always restrained with one coil spring 42.

In this embodiment, the nut arrangement part 11 into which the nut unit 40 is accommodated is not opened in a direction (“X” direction) in which the main body part 9 and the frame main body 2a are faced each other but is opened in a direction (“Y” direction) intersecting the “X” direction. This is especially preferable to enhance workability when the nut unit 40 is to be disposed in an inside of the nut arrangement part 11. In other words, when the nut arrangement part 11 is opened in a direction facing the frame main body 2a, an inside of the nut arrangement part 11 cannot be confirmed by visual observation due to the frame main body 2a and thus it is difficult that the nut unit 40 is accommodated in the nut arrangement part 11 in an appropriate arrangement position. On the other hand, in this embodiment, when the nut unit 40 is to be accommodated in the nut arrangement part 11, the nut unit 40 is not obstructed by the frame main body 2a and thus the nut unit 40 can be arranged at an appropriate position while confirming by visual observation and reduction in yield at the time of assembling can be suppressed.

In this embodiment, as described above, the guide shaft 5 and the lead screw 4 are disposed so as to be overlapped with each other in the “X” direction. The support part 10 is provided so as to be overlapped with the guide shaft 5 and the lead screw 4 in the “X” direction. Therefore, the movable member 6 can be moved stably. Further, in this embodiment, a pair of stoppers 9b and 9c (see FIGS. 3 and 4) for restricting turning of the main body part 9 is provided in a lower part of the main body part 9, and distances from the guide shaft 5 to the respective stoppers 9b and 9c can be set substantially equal to each other. Therefore, rattling in a turning direction of the movable member 6 is capable of being restrained as small as possible and movement of the movable member 6 can be stabilized.

In the embodiment described above, each of the first nut member 41 and the second nut member 43 is separately provided from the main body part 9. However, it is sufficient that the first nut member 41 is structured so as to be moved together with the main body part 9 and thus the first nut member 41 is not required to be separately provided from the main body part 9. In other words, the first nut member 41 may be directly fixed to the main body part 9 by a fixing means such as an adhesive and, alternatively, it may be structured that the first nut member 41 and the main body part 9 are integrally formed with each other and the main body part 9 itself is provided with a female screw part which is threadedly engaged with the lead screw 4.

Although the present invention has been shown and described with reference to a specific embodiment, various changes and modifications will be apparent to those skilled in the art from the teachings herein. For example, the above-mentioned feeding drive device 1 may be applied to a device other than the head-up display device 1000.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A drive device comprising:
a drive part; and
a movable member structured to be moved by a drive force of the drive part;
wherein the movable member comprises a main body part and a support part which supports a supported member;
wherein the support part comprises:
an elastic support part which urges the supported member; and
a fixed support part which is provided so as to face the elastic support part in a moving direction of the movable member and supports the supported member urged by the elastic support part;
wherein the elastic support part comprises an elastic support part side protruded part which is a convex curved face protruded to a side to be abutted with the supported member; and
wherein the fixed support part comprises a fixed support part side protruded part which is a convex curved face protruded to a side to be abutted with the supported member.

2. The drive device according to claim 1, wherein
the elastic support part comprises an elastic member having the elastic support part side protruded part and an elastic member fixing part which holds the elastic member, and
the elastic member fixing part is provided in the main body part.

3. The drive device according to claim 2, wherein
the elastic member is a plate spring.

4. The drive device according to claim 2, wherein
the elastic member fixing part comprises a moving range restriction part which restricts a moving range of the elastic member.

5. The drive device according to claim 2, wherein
the elastic member comprises a fixed plate part attached to the elastic member fixing part and an elastically deformable plate part which is extended from an end part of the fixed plate part and is elastically deformable,
the elastically deformable plate part comprises a first elastic part extended from an end part of the fixed plate part and a second elastic part extended from an end part of the first elastic part, and
the second elastic part comprises an abutting part structured to abut with the supported member.

6. The drive device according to claim 5, wherein
the first elastic part is extended on an extended line of the fixed plate part, and
the second elastic part is extended at an acute angle with respect to the first elastic part.

7. The drive device according to claim 6, wherein
a first supporting point part is formed between the fixed plate part and the first elastic part,
the first supporting point part is defined as a boundary part between a region where the elastic member is held by the elastic member fixing part and a region where the elastic member is not held by the elastic member fixing part, and
the first elastic part is elastically deformable with respect to the fixed plate part with the first supporting point part as a support point.

8. The drive device according to claim 5, wherein
the elastic member fixing part comprises a protruded part which is protruded from the main body part and a restriction part provided in the protruded part, and
the restriction part is formed with a gap space into which the fixed plate part is inserted between the protruded part and the restriction part to restrict a movement of the fixed plate part in a direction intersecting an inserting direction to the gap space.

9. The drive device according to claim 8, wherein
the elastic member fixing part comprises an engaging part provided in the protruded part, and
the engaging part is engaged with the fixed plate part inserted into the gap space to restrict a movement of the fixed plate part to an opposite direction to the inserting direction to the gap space.

10. The drive device according to claim 5, wherein
the elastic member fixing part comprises a protruded part which is protruded from the main body part, and
the protruded part is formed with a relief part which avoids an interference with the elastically deformable plate part.

11. The drive device according to claim 10, wherein
the relief part is a stepped part formed in the protruded part, and
the stepped part is formed in a corner part of the protruded part which faces the second elastic part and has a width wider than a width of the second elastic part.

12. The drive device according to claim 1, wherein
the fixed support part is formed of material having higher rigidity than the main body part and is partly embedded and fixed to the main body part.

13. The drive device according to claim 12, wherein
the fixed support part supports the supported member at a position facing the supported member in a moving direction of the movable member.

14. The drive device according to claim 1, wherein
at least one of the elastic support part side protruded part and the fixed support part side protruded part comprises a convex curved face and is abutted with the supported member through the convex curved face.

15. The drive device according to claim 1, wherein
an abutting direction of the elastic support part side protruded part with the supported member deviates from a position of the fixed support part side protruded part.

16. The drive device according to claim 1, further comprising a lead screw which is rotationally driven by the drive part,
wherein the movable member comprises a drive force transmission part structured to transmit a drive force of the drive part to the main body part and a pressurization applying part separately provided from the main body part,
wherein the drive force transmission part comprises a first threaded part which is threadedly engaged with the lead screw and moves the main body part in an axial line direction of the lead screw accompanied with rotation of the lead screw, and
wherein the pressurization applying part comprises a second threaded part which is threadedly engaged with the lead screw and pressurization is applied between the first threaded part and the second threaded part.

17. The drive device according to claim 16, wherein
the drive force transmission part comprises a first nut member comprising the first threaded part and is separately provided from the main body part,
the pressurization applying part comprises a second nut member comprising the second threaded part and an urging member provided between the first nut member and the second nut member,
the main body part comprises a nut arrangement part in which the first nut member and the second nut member are disposed, and
the first nut member and the second nut member are disposed in the nut arrangement part in a state that turnings of the first nut member and the second nut member with respect to the main body part are restricted.

18. The drive device according to claim 17, wherein
the nut arrangement part comprises a drive force receiving part which receives the drive force of the drive part through the first nut member, and
the first nut member is applied with pressurization by the urging member through the drive force receiving part.

19. The drive device according to claim 18, wherein
the urging member is a coil spring,
the lead screw penetrates through an inside of the coil spring, and
the urging member is disposed between the drive force receiving part and the second nut member.

20. A head-up display device comprising:
the drive device defined in claim 1.
